(19) United States
(12) Patent Application Publication
(10) Pub. No.: US 2007/0231062 A1
(43) Pub. Date: Oct. 4, 2007

(54) METHOD FOR JOINING PLANAR SHEETS AND SHEETS THEREFOR

(75) Inventor: Max W. Durney, San Francisco, CA (US)

Correspondence Address: MORGAN, LEWIS & BOCKIUS, LLP, ONE MARKET SPEAR STREET TOWER, SAN FRANCISCO, CA, 94105, US

(73) Assignee: Industrial Origami, LLC, San Francisco, CA (US)

(21) Appl. No.: 11/611,100

(22) Filed: Dec. 14, 2006

Related U.S. Application Data
(60) Provisional application No. 60/753,529, filed on Dec. 22, 2005.

(51) Int. Cl. B23P 11/00; F16G 11/05

(52) U.S. Cl. 403/275; 29/428

(57) ABSTRACT

A plane-to-plane joint is configured for securing planar segments of one or more sheet materials together without the need for additional fasteners. The plane-to-plane joint includes a first planar segment having an upper planar surface, a second planar segment having a lower planar surface, a joinder structure monolithically formed on the first planar segment, the joinder structure including a transition zone located below the upper planar surface and a registration zone extending upwardly from the transition zone and out-of-plane from the planar segment, and an aperture in the second planar segment for receiving the joinder structure. The aperture is dimensioned and configured to cooperate with the registration zone of the joinder structure to register the relative position of the first and second planar segments when the lower planar surface abuts against the upper surface. A method of making and using the plane-to-plane joint is also disclosed.

### BACKGROUND OF THE INVENTION

1. Field of the Invention

The present invention relates, in general, to apparatus and methods for joining together planar segments of sheet material(s), and more particularly, relates to a plane-to-plane joint having joinder structures capable of accurately registering planar segments to one another for precise, fastener-free coupling.

2. Description of Related Art

Various methods may be employed to form three-dimensional structures from two dimensional sheet materials. For example, U.S. Pat. No. 6,877,349 entitled METHOD FOR PRECISION BENDING OF SHEET OF MATERIALS, SLIT SHEETS FABRICATION PROCESS, and U.S. Pat. No. 6,481,259 entitled METHOD FOR PRECISION BENDING OF A SHEET OF MATERIAL AND SLIT SHEET THEREFOR, both to Industrial Origami, LLC, the assignee of the present invention, set forth in considerable detail apparatus and methods for precisely controlling bending or folding of sheet materials along fold lines to form three-dimensional structures. The sheet materials are provided with a plurality of folding structures along a desired fold line, which folding structures will produce folding of the sheets along the fold lines in a manner that can very precisely be controlled. The folding structures are typically slits, grooves or displacements that are positioned on alternating sides of the desired fold line so as to define spaced-apart bending or folding straps that precisely control folding of the sheet. The sheet materials described in the above-mentioned patents may be used to provide three-dimensional structures including, but not limited to, electronic component chassis for computers, audio receivers, televisions, DVD players, motor vehicles, autos, construction, aerospace, appliances, industrial packaging and other non-electronics-related goods.

In some instances, the folded sheets of the above-mentioned patents have been used to produce three-dimensional structures in which portions of the sheet(s) are folded into overlapping relation and then are joined together to stabilize the resulting structure against unfolding. The previous techniques for securing the overlapping portions of the folded sheet(s) together have varied considerably, depending upon the application, but in many instances the portions have merely been joined together using standard mechanical fasteners such as screws, rivets, nuts and bolts, and other mechanical fasteners. While such mechanical fasteners are quite effective in securing the overlapping portions together, they increase the number of parts required to create a structure. Furthermore, such mechanical fasteners generally increase the time, labor and/or costs involved in creating the structure. For example, corresponding assembly holes must be formed, the fasteners must be aligned with and inserted through the assembly holes, and the fasteners, in turn, must be fastened.

Other means of Joining overlapping portions of sheet material(s) together are known including welding, brazing and adhesives. Again, such means are quite effective in securing overlapping sheet materials together, but such means also increase time, labor and/or costs involved. For example, welding requires the use of skilled labor and/or the use of expensive and complex automated welding equipment. One major disadvantage of such means is that registration of the overlapping portions, that is, the precise alignment of one overlapping portion with respect to the other, must be accomplished by other additional means. For example, clamps or jigs must be used to temporarily align and secure the overlapping portions to one another until the portions are secured by welding, brazing, and the like.

While other methods have been devised to allow joinder of overlapping sheet materials without the use of standard mechanical fasteners, such other methods also require additional means for registration of the overlapping sheets with one another before the sheets are secured to one another. For example, U.S. Pat. No. 4,760,634 to Rapp discloses a method of connecting thin plates. The Rapp patent, however fails to disclose any means provided on the thin plates adjacent the swaged connection which effect registration of the thin plates to one another prior to swaging the plates together.

What is needed is an apparatus and method of joining planar segments of sheet material(s) together in a manner that will allow fastener-free and self-registering joinder of the planar segments of sheet materials.

### BRIEF SUMMARY OF THE INVENTION

One aspect of the present invention is directed to a plane-to-plane joint for securing planar segments of one or more sheet materials together. The plane-to-plane joint includes a first planar segment having an upper planar surface, a second planar segment having a lower planar surface, a joinder structure monolithically formed on the first planar segment, which joinder structure includes a transition zone located below the upper planar surface and a registration zone extending upwardly from the transition zone and extending out-of-plane from the planar segment. The plane-to-plane joint further includes the second planar segment having an aperture there through for receiving the joinder structure. The aperture is dimensioned and configured to cooperate with the registration zone of the joinder structure to register the relative position of the first and second planar segments when the lower planar surface of the second planar segment abuts against the upper surface of the first planar segment.

Preferably, the transition zone does not contact the second planar segment when the lower planar surface is placed against the upper planar surface. The joinder structure may include a tapered zone extending above the registration zone, in which the tapered zone is dimensioned and configured to engage the aperture and align the aperture relative to the registration zone. The registration zone may be tubular and the tapered zone may be frustoconical. The tapered zone may have an open top. The joinder structure may include a closed semi-spherical ton extending above the tapered zone and/or above the registration zone. The first planar segment and the second planar segment may be monolithically formed. Preferably, at least one of the joinder structure and the aperture is formed by stamping, punching, roll forming, or embossing. The joinder structure may have a tapered zone above the registration zone, and the tapered zone may be flattened against an upper surface of the second planar segment thereby firmly and/or permanently securing the first and second planar segments together. The tapered zone may be flattened against the upper surface by stamping, punching, roll forming, or embossing.

Another aspect of the present invention is directed to a method for securing planar segments of one or more sheet materials together. The method includes the step of monolithically forming a joinder structure on the first planar segment having an upper planar surface, in which the joinder structure including a transition zone located below the upper planar surface, and a registration zone extending upwardly from the transition zone and out-of-plane from the planar segment. The method further includes the step of forming an aperture in a second planar segment having a lower planar surface, wherein the aperture is dimensioned and configured to receive the joinder structure and to cooperate with the registration zone of the joinder structure to register the relative position of the first and second planar segments when the lower planar surface of the second segment abuts against the upper surface of the first segment.

The method may further include the step of monolithically forming the first and second planar segments from a single sheet of material. At least one of the monolithically forming steps and the aperture forming step may be accomplished by one of a stamping process, a punching process, a roll forming process, or an embossing process. The monolithically forming step may be accomplished by forming a tapered zone extending above the registration zone. The tapered zone may be dimensioned and configured to engage the aperture and align the aperture relative to the registration zone. The method may further include the step of flattening the tapered zone against an upper surface of the second planar segment to permanently secure the first and second planar segments together. The tapered zone may be flattened against the upper surface of the second planar segment by stamping, punching, roll forming, or embossing.

The method for joining planar sheets and the sheets therefor of the present invention has other features and advantages which will be apparent from or are set forth in more detail in the accompanying drawings, which are incorporated in and form a part of this specification, and the following Detailed Description of the Invention, which together serve to explain the principles of the present invention.

### BRIEF DESCRIPTION OF THE DRAWINGS

FIG. 1 is a perspective view of a plane-to-plane joint of two planar sheet material segments in accordance with the present invention, in which the sheet material segments are shown prior to joinder.

FIG. 2 is a perspective view of the plane-to-plane joint of FIG. 1, the sheet material segments being shown after joinder.

FIG. 3 is a cross-sectional view of the plane-to-plane joint of FIG. 1 before joinder, taken substantially along line 3-3 of FIG. 1.

FIG. 4 is a cross-sectional view of the plane-to-plane joint of FIG. 1 after joinder, taken substantially along line 4-4 of FIG. 2.

FIG. 5 is a cross-sectional view of another plane-to-plane joint in accordance with the present invention, similar to that shown in FIG. 1 and being shown prior to joinder.

FIG. 6 is a cross-sectional view of the plane-to-plane joint of FIG. 5 after joinder.

FIG. 7. is a perspective view of the plane-to-plane joint of FIG. 5.

FIG. 8 is a perspective view of the plane-to-plane joint of FIG. 6.

FIG. 9 is a perspective view of a three dimensional structure formed by the fastening of two planar sheet material segments made of a single sheet material utilizing the plane-to-plane joint of FIG. 1.

FIG. 10 is a perspective view of a three dimensional structure formed by the fastening of two planar sheet material segments made of a single sheet material utilizing the plane-to-plane joint of FIG. 5.

FIGS. 11A, 11B, 11C, and 11D are a series of cross-sectional views of another plane-to-plane joint in accordance with the present invention, similar to that shown in FIG. 1, and being shown well before joinder, during initial registration but before joinder, after initial registration but before joinder, and after joinder, respectively.

FIGS. 12A, 12B, 12C, and 12D are a series of cross-sectional views of yet another plane-to-plane joint in accordance with the present invention, similar to that shown in FIG. 1, and being shown well before joinder, during initial registration but before joinder, after initial registration but before joinder, and after joinder, respectively.

FIGS. 13A, 13B, 13C, and 13D are a series of cross-sectional views of still another plane-to-plane joint in accordance with the present invention, similar to that shown in FIG. 1, and being shown well before joinder, during initial registration but before joinder, after initial registration but before joinder, and after joinder, respectively.

FIG. 14 is a perspective view of another three dimensional corner structure formed by the fastening of two planar sheet material segments made of a single sheet material utilizing the plane-to-plane joint of FIG. 5.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to those embodiments. On the contrary, the invention is intended to cover alternatives, modifications and equivalents, which may be included within the spirit and scope of the invention as defined by the appended claims.

Assignee's following U.S. Patent Application and Patents set forth in considerable detail apparatus and methods for bending or folding sheet materials to form three dimensional structures: 60/720,417 entitled METHOD FOR FORMING ANGLES AND CLOSURES IN SHEET MATERIAL AND SHEET THEREFOR; 11/180,398 entitled METHOD FOR INCREASING THE FATIGUE RESISTANCE OF STRUCTURES FORMED BY BENDING SLIT SHEET MATERIAL AND PRODUCTS RESULTING THEREFROM; 60/682,057 entitled METHOD AND TOOLING FOR FORMING SHEET MATERIAL WITH BEND CONTROLLING DISPLACEMENTS; 60/663/392 entitled PRECISION-FOLDED, HIGH STRENGTH, FATIGUE-RESISTANT STRUCTURES AND SHEET THEREFOR; 11/080,288 entitled SHEET MATERIAL WITH BEND CONTROLLING DISPLACEMENTS AND METHOD FOR FORMING THE SAME; 60/654,545 entitled APPARATUS AND METHOD FOR JOINING THE EDGES OF FOLDED SHEET MATERIAL TO FORM THREE-DIMENSIONAL STRUCTURE; 10/985,373 entitled PROCESS OF FORMING BEND-CONTROLLING STRUCTURES IN A SHEET OF MATERIAL, THE RESULTING SHEET AND DIE SETS THEREFOR (now US 2005-0061049 A1); 10,952,357 entitled METHOD FOR PRECISION BENDING OF SHEET OF MATERIALS, SLIT SHEETS FABRICATION PROCESS (now US 2005-0064138 A1); 10/931,615 entitled SHEET MATERIAL WITH BEND CONTROLLING GROOVES DEFINING A CONTINUOUS WEB ACROSS A BEND LINE AND METHOD FOR FORMING THE SAME (now US 2005-00971937 A1); 60/587,470 entitled METHOD FOR INCREASING THE FATIGUE RESISTANCE OF STRUCTURES FORMED BY BENDING SLIT SHEET MATERIAL AND PRODUCTS RESULTING THEREFROM; 10/861,726 entitled TECHNIQUES FOR DESIGNING AND MANUFACTURING PRECISION-FOLDED, HIGH STRENGTH, FATIGUE-RESISTANT STRUCTURES AND SHEET THEREFOR (now US 2005/0126110 A1); 10/821,818 entitled METHOD OF DESIGNING FOLD LINES IN SHEET MATERIAL (now US 2005-0005670 A1); 10/795,077 entitled SHEET MATERIAL WITH BEND CONTROLLING DISPLACEMENTS AND METHOD FOR FORMING THE SAME (now US 2004-0206152 A1); 10/672,766 entitled TECHNIQUES FOR DESIGNING AND MANUFACTURING PRECISION-FOLDED, HIGH STRENGTH, FATIGUE-RESISTANT STRUCTURES AND SHEET THEREFOR (now US 2004/0134250 A1); 6,877,349 entitled METHOD FOR PRECISION BENDING OF SHEET OF MATERIALS, SLIT SHEETS FABRICATION PROCESS; and 6,481,259 entitled METHOD FOR PRECISION BENDING OF A SHEET OF MATERIAL AND SLIT SHEET THEREFOR. The entire contents of Assignee's above-mentioned patents and patent applications is incorporated herein by this reference.

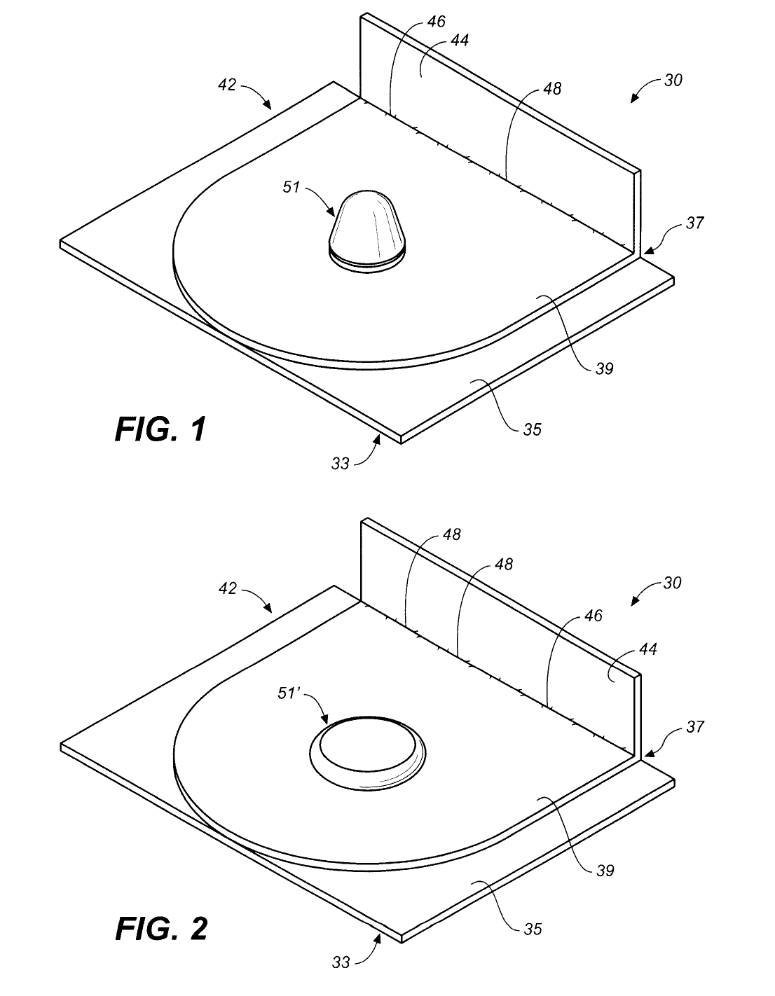

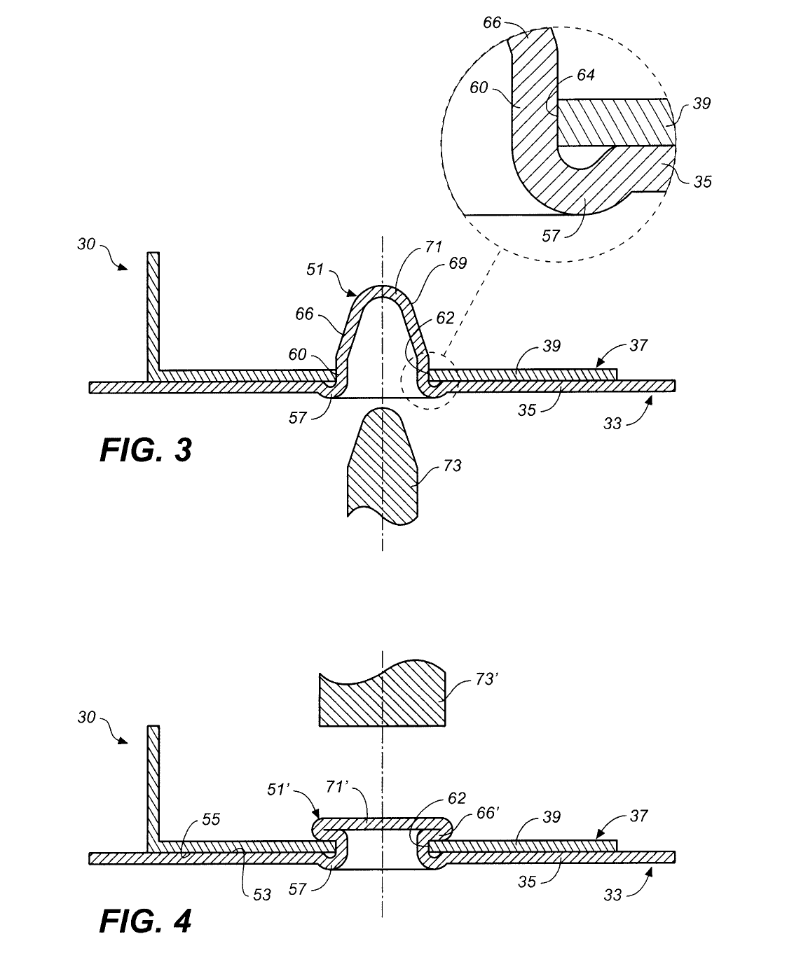

Turning now to the drawings, wherein like components are designated by like reference numerals throughout the various figures, attention is directed to FIG. 1 and FIG. 3 which illustrate a three-dimensional bracket formed from two-dimensional sheets of material in accordance with the present invention, which bracket is generally designated by the numeral 30. While the illustrated embodiment is a bracket assembly, one will appreciate that a number of three-dimensional structures including, but not limited to, electronic component chassis for computers, electrical boxes, audio receivers, televisions, DVD players, telephones, wireless communication devices, vehicles, construction, aerospace, packaging, appliances, industrial, metal and other non-electronics-related goods may be formed in accordance with the present invention.

In the illustrated embodiment, the bracket includes a first lower sheet of material 33 having a first lower planar segment 35, and a second upper sheet of material 37 having a second upper planar segment 39. The lower and upper planar segments are rigidly interconnected by a plane-to-plane joint 42. In the illustrated embodiment, the second sheet has a substantially perpendicular additional planar segment 44, in which the adjoining planar segments 39 and 44. are separated by a fold line 46 populated by one or more bend-controlling structures 48 formed by various methods as described in the Assignee's Patents and pending Patent Applications cited above and incorporated herein by reference. One will appreciate that either sheet of material may be provided with one, two, three or more planar segments separated by corresponding fold lines depending upon the desired overall geometry of the resulting three-dimensional structure. The bend-controlling structures and other principles which control precise sheet material folding are set forth in more detail in Assignee's above-mentioned Patents and Patent Applications.

In the illustrated embodiments, the sheet material is 18-gauge sheet steel. However, one will appreciate that other sheet materials of different materials including other metals, composites and plastics, as well as other gauges can be utilized in accordance with the present invention. For example, 16-gauge sheet material, 18-gauge sheet material, 20-gauge sheet or relatively thin or relatively thick sheet materials and other suitable thickness sheet material may be used. Also, other sheet materials and planar members may be used including, but are not limited to, stainless steel, aluminum, and other suitable metals and alloys. Also, one will appreciate that other materials may be used including, but not limited to, composites, plastics, magnesium and other suitable materials.

One will further appreciate that the sheets need not be of the same material or thickness. For example, the lower planar member, which includes joinder structure as will be discussed below, may be formed of metal and/or other ductile and malleable materials. The upper planar member may be formed of any material which may receive an aperture, including metals, plastics, ceramics, and other suitable materials. Also, the planar members need not have the same thickness. For example, the lower planar member may be formed of 16-gauge aluminum, and the upper planar member may be formed of inch-thick plastic, provided that the joinder structure is tall enough to extend through the aperture of the upper planar member, as will become evident below.

With reference to FIG. 3 , first planar segment 35 of the lower sheet includes a joinder structure 51 which extends primarily upwardly out-of-plane beyond an upper planar surface 53 such that it extends higher than a lower planar surface 55 of upper planar segment 39 when the upper planar segment is resting on the lower planar segment. Preferably, the joinder structure is monolithically formed with the first planar segment.

The joinder structure includes a transition zone 57 that is configured and dimensioned such that it does not directly contact the upper planar segment 39. In the illustrated embodiment, the transition zone is an annular region which does not directly contact the upper planar segment. Preferably, the transition zone is displaced downwardly from upper surface 53 of the lower planar segment such that the upper surface thereof does abut against the lower surface 55 of the upper planar segment and thus does not interfere with the proper registration of the upper and lower planar segments during assembly, as will become evident below. Alternatively, the transition zone may include a depressed swaged indentation formed by stamping, punching or other suitable means.

The joinder structure further includes a registration zone 60 extending upwardly from the transition zone and out-of-plane from lower planar segment 35. In the illustrated embodiment, the registration zone is a tubular region that extends substantially perpendicular to the lower planar segment 35. Preferably, the registration zone extends upwardly a distance that is greater than the thickness of upper planar segment 39, as will also become evident below.

An aperture 62 is provided in the upper planar segment 39 for receiving joinder structure 51. The aperture has an inner wall 64 that is dimensioned and configured to cooperate with the registration zone of the joinder structure to precisely register the relative position of the lower and upper planar segments, that is, precisely align the relative position of the lower and upper planar segments, when the lower planar surface abuts against the upper surface. Preferably the outside diameter of registration zone 60 is substantially equal to the inside diameter of aperture 62 preferably having tolerances of approximately 0.050 inches or less, more preferably 0.010 inches or less, and most preferably 0.005 inches or less. In the illustrated embodiment, the aperture and its inner wall is substantially cylindrically shaped and extends substantially perpendicular to the upper planar segment.

While registration zone 60 and aperture 62 are preferably round, one will appreciate that the registration zone and the aperture may have other geometric configurations including, but not limited to, oval shapes, oblong shapes, substantially triangular shapes, square or rectangular shapes, and/or other suitable shapes. Similarly, while the registration zone and the aperture are preferably substantially perpendicular to the planar segments in which they are provided, they need not be perpendicular to the planar segments and may extend obliquely to the planar segments. In accordance with the present invention, the registration zone and aperture should be complementarily shaped and dimensioned so as to provide precise registration between the planar segments.

The joinder structure further includes a narrowing tapered zone 66 extending above registration zone 60. The tapered zone is configured to align the inner wall of aperture 62 with the registration zone as the joint is assembled and in particular, when the upper planar segment is brought into contact with the lower planar segment. In the illustrated embodiment, the tapered zone is frustoconical, extending away from the registration zone and having a narrowed end 69 terminating in a closed semi-spherical top 71. The tapered zone and closed top may take other shapes depending upon the shape of the aperture and the registration zone, which may vary as discussed above.

Turning now to FIG. 3, various processes including stamping, punching, roll forming, embossing and other suitable means may be utilized to form joinder structure 51 and/or the joinder aperture 62 in the respective planar segments of sheet material. For example, a punch die 73 or other suitable tooling may be utilized to form the joinder structures. Preferably the joinder structure and/or the joinder aperture are formed simultaneously with the above-mentioned bend controlling structures 48. For example, the joinder structure and/or the joinder aperture may be formed simultaneously with the bend-controlling structures by stamping, punching, roll forming, embossing and/or other suitable means similar to those bend-controlling structures described in Assignee's above-mentioned Patents and Patent Applications. One or more sets of joinder structure and joinder apertures may be stamped, punched or otherwise formed in the respective planar segments.

In the illustrated embodiment, the joinder structure and the joinder apertures are formed simultaneously with the bend-controlling structures. Such simultaneous formation may serve to minimize manufacturing tolerances between the joinder structure and the joinder apertures, as well as serve to minimize manufacturing tolerances between these and the bend-controlling structures. However, one will appreciate that the joinder structure and joinder apertures may be formed independently of the bend-controlling structures. For example, the joinder structure and/or the joinder aperture may be formed before or after the bend-controlling structure, and with similar means or different means. For example, the bend-controlling structures could be stamped while the joinder structure and/or the joinder aperture are punched. One will appreciate that forming the joinder structure and/or the joinder aperture may be done independently.

A method of using plane-to-plane joint 42 in accordance with the present invention can now be described. Turning now to FIG. 3, Joinder structure 51 is aligned with aperture 62 and tapered zone 66 of the joinder structure is inserted through the aperture. As joinder structure penetrates the aperture, the outer surface of the tapered zone will contact inner wall 64 of the aperture and serve to align and center the joinder structure with respect to the aperture. As Joinder structure continues to penetrate the aperture, registration zone 60 engages the inner wall of the aperture, so that precise registration of upper and lower planar segments 35 and 39 is effected. In particular, the close tolerances between registration zone 60 and inner wall 64 allow little, if any, play between the upper and lower planar segments.

As transition zone 57, is displaced downwardly from upper surface 53 of the lower planar segment, the lower edge of inner wall 64 moves downwardly unobstructed and thus allows the lower surface 55 of the upper planar segment 39 to rest directly against the upper surface 53 of lower planar segment 35. Such configuration advantageously obviates the need for greater tolerances between the joinder structure and the aperture and thus serves to allow for more precise registration.

Once the upper and lower segments are properly registered, that is, aligned with one another, and the lower surface 55 of the upper planar segment is abutting against the upper surface 53 of the lower planar segment, the joinder structure may be deformed to affix the planar segments together without the need for discrete fasteners or fastening means. In particular, tapered zone 66, and any portion of the registration zone extending above upper planar segment 39, is flattened against the upper surface of the upper planar segment thus permanently affixing the planar segments together. The tapered zone may be flattened against the upper surface by stamping, punching, roll forming, or embossing or other suitable means. For example, a punch die 73′ or other suitable tooling may be utilized to flatten the tapered zone.

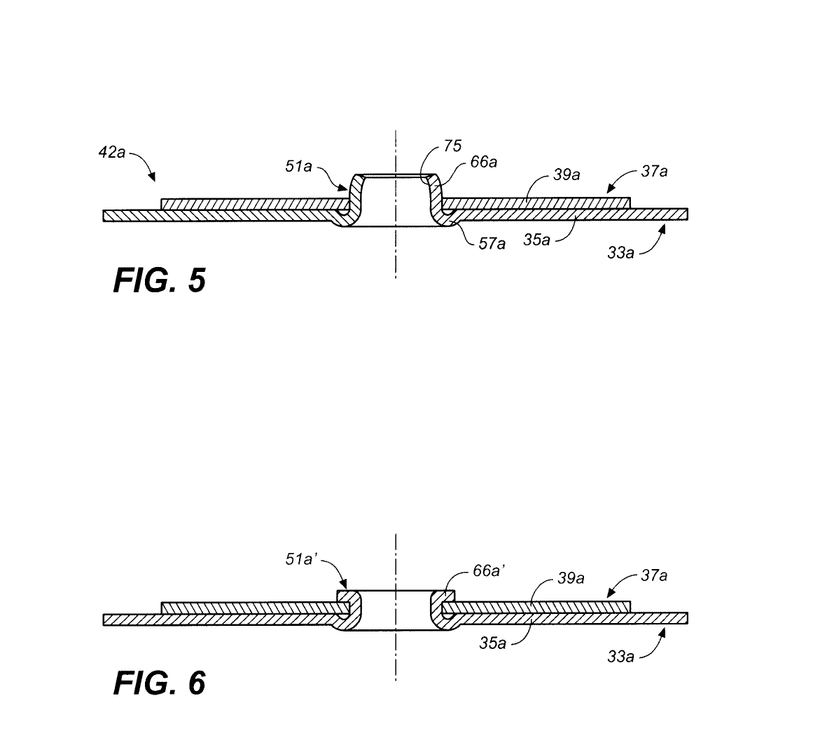

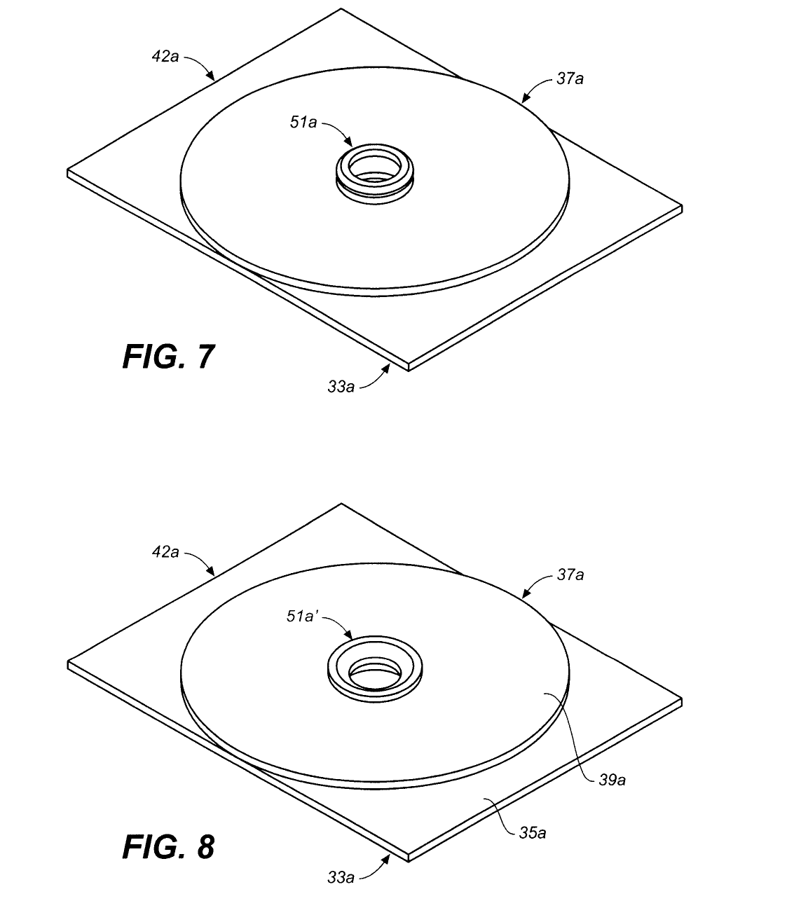

In another embodiment of the present invention, plane-to-plane joint 42a is similar to plane-to-plane joint 42 described above but includes an open joinder structure 51a as shown in FIG. 5. Like reference numerals have been used to describe like components of plane-to-plane joint 42 as plane-to-plane joint 42a. In this embodiment, joinder structure 51a has a tapered zone 66a that has an open top 75. In operation and use, joinder structure 51a is used in substantially the same manner as joinder structure 51 discussed above.

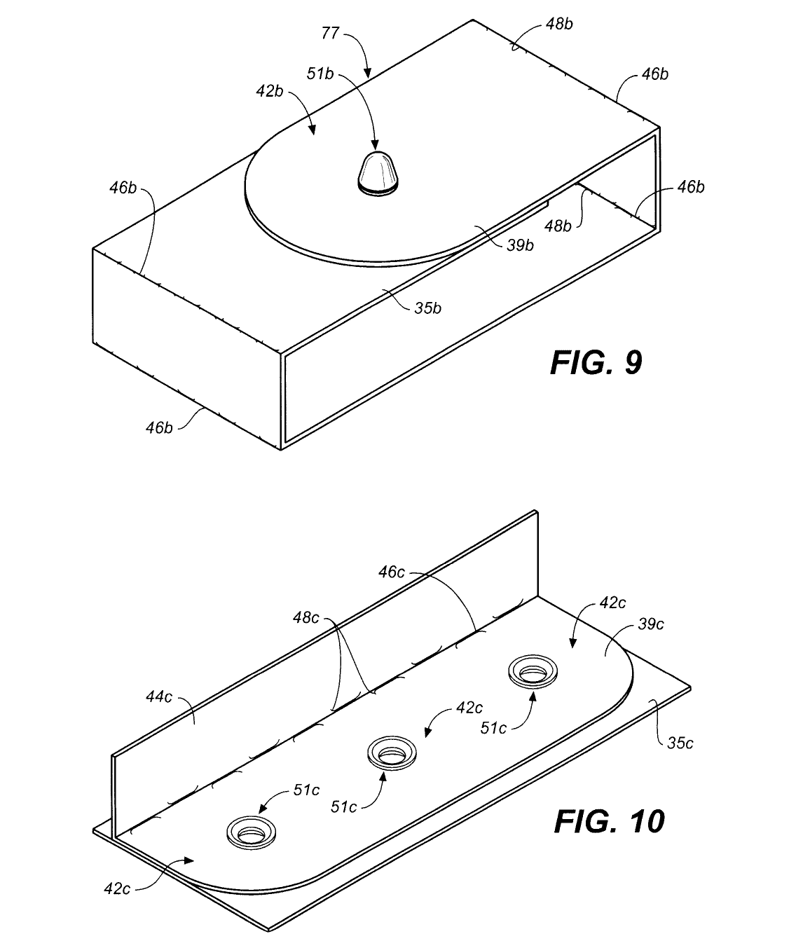

In another embodiment of the present invention, plane-to-plane joint 42b is similar to plane-to-plane joints 42 and 42a described above but has both lower planar segment 35b and upper planar segment 39b formed on a single sheet of material 77, as shown in FIG. 9. Again, like reference numerals have been used to describe like components of plane-to-plane joints 42, 42a and 42b. In this embodiment, joinder structure 51b and joinder aperture are formed in respective lower and upper planar segments 35b and 39b, which in turn are monolithically formed from a single sheet of material. In operation and use, joinder structure 51b is used in substantially the same manner as the joinder structures discussed above, except that two ends of a single sheet of material 77 are folded along fold lines 46b using bend-controlling structures 48b to overlap one another and then secured together as opposed to securing two separate sheets of material.

In still a further embodiment of the present invention, plane-to-plane joint 42c is similar to the plane-to-plane joints described above but has multiple sets of joinder structure 51c and the joinder aperture 62c provided on respective lower and upper planar segments 35c and 39c, as shown in FIG. 10. Again, like reference numerals have been used to describe like components of plane-to-plane joints 42, 42a and 42b. In this embodiment, multiple joinder structures 51c and a corresponding number of joinder apertures are formed in respective lower and upper planar segments 35c and 39c. In operation and use, joint c is used in substantially the same manner as the joints discussed above, except a plurality of joinder structures are inserted into the corresponding apertures and then the joinder structures are deformed to secure the planar segments together.

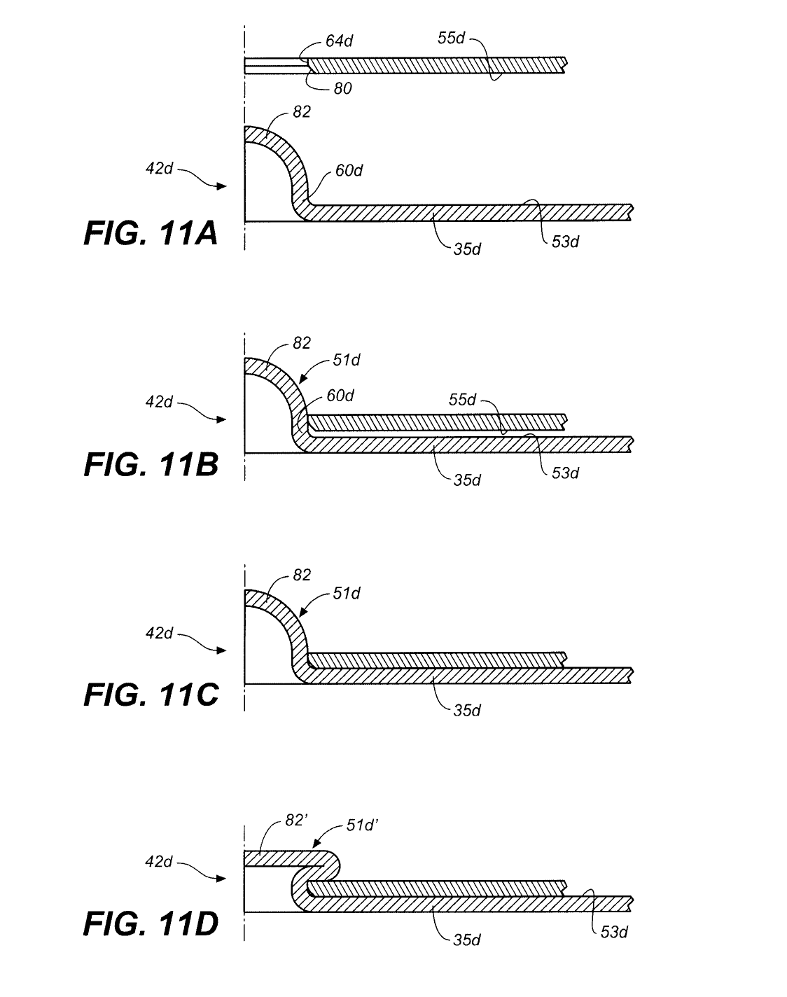

Turning now to FIGS. 11A-11D, another embodiment of the present invention includes plane-to-plane joint 42d that is similar to the plane-to-plane joints described above but includes a chamfered aperture 80 in upper sheet 37d instead of a transition zone in the lower sheet, Like reference numerals have been used to describe like components of plane-to-plane joint 42d as the above-described plane-to-plane joints. In particular, the lower edge of the aperture includes a chamfer that is dimensioned and configured to accommodate for the deformation that occurs between lower planar segment 35d and registration zone 60d, as shown in FIG. 11A. In this embodiment joinder structure 51d has substantially semi-spherical bulb 82 which serves as both the tapered zone and the top discussed above, however, one will appreciate that a tapered zone may be utilized.

As is the case with the registration zones discussed above, registration zone 60d also is substantially equal to the minimum diameter of the aperture, is substantially cylindrically shaped, and extends substantially perpendicular to the lower planar segment. The dimensions and configuration of registration zone 60d allow the inner wall 64d of the chamfered aperture to contact the registration zone and effect proper positioning or registration of the upper sheet with respect to the lower sheet as the upper sheet is applied to the lower sheet, as shown in FIG. 11B. Furthermore, the registration zone maintains proper registration between the upper and lower sheets as lower surface 55d 53d, as shown in FIG. 11C, allowing precise alignment when joinder is complete, as shown in FIG. 11D. Thusly, in operation and use, joinder structure 51d is used in substantially the same manner as the joinder structures discussed above.

As can be seen in FIGS. 11A-C, the registration zone of the present invention is particularly useful in indexing two planar surfaces with respect to one another. Furthermore, with reference to FIG. 10, having two or more joinder structures with registration zones is particularly useful in indexing and aligning two planar surfaces. Accordingly, one will appreciate that the registration zones may be utilized to index and/or align two or more planar sheets in accordance with the present invention, whether or not the joinder structure of the lower sheet is cinched against the upper sheet. In such cases, one will appreciate that other fastening means may be used to secure the planar members together. For example, adhesives, mechanical fasteners such as rivets, and other suitable fastening means may be used to affix the planar members together instead of, or in addition to, the joinder structure.

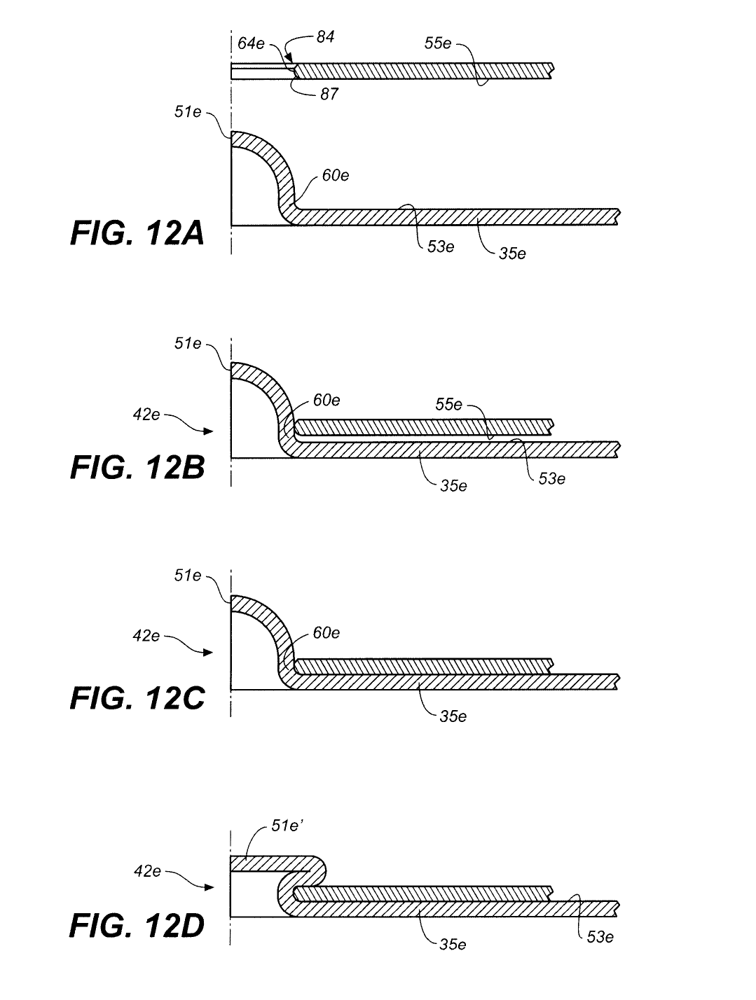

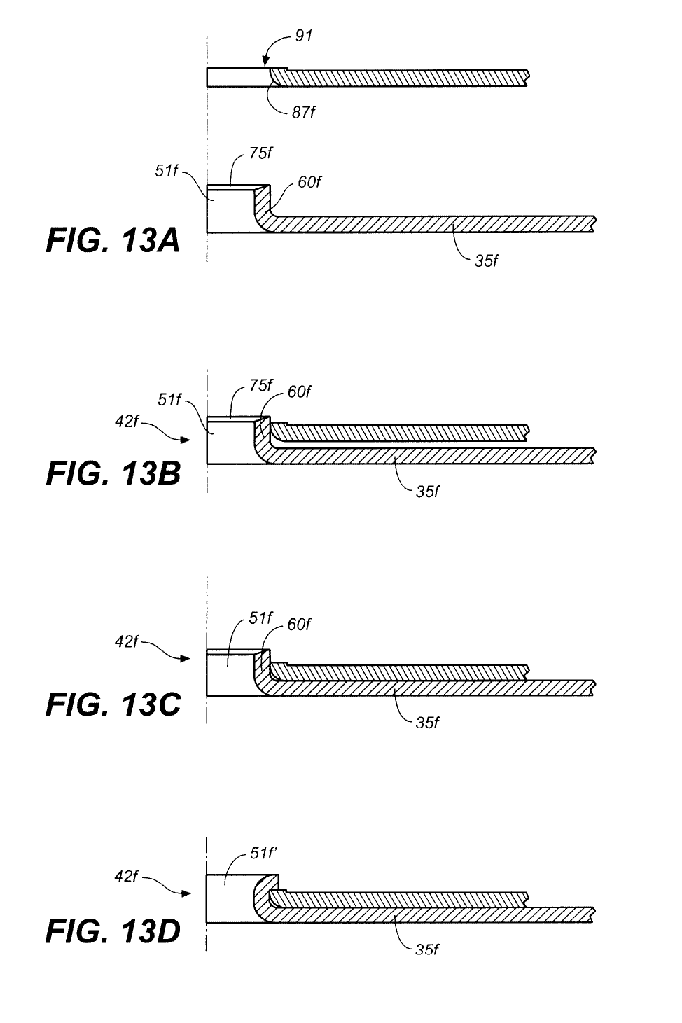

Yet another embodiment of the present invention includes plane-to-plane joint 42e that similar to those described above but includes a punched aperture 84. Like reference numerals have been used to describe like components of plane-to-plane joint 42e as the above-described plane-to-plane joints. In this embodiment, the lower edge of the aperture includes a fillet 87 that is formed by punching, stamping, rolling, and/or other suitable means. The fillet provides the clearance for the deformation that occurs between lower planar segment 35e and registration zone 60e, as shown in FIG. 12A. In this embodiment, joinder structure 51e also has a substantially semi-spherical bulb 89e, but one will appreciate that a tapered zone may be utilized.

Again, registration zone 60e is substantially equal to the minimum diameter of the aperture, and extends substantially perpendicular to the lower planar segment. Preferably, the radius of the fillet is substantially equal but slightly greater than, or merely greater than, the radius of the resulting deformed portion interconnecting the lower planar segment 35e and the registration zone 60e such that inner wall 64e of the punched aperture contacts the registration zone and effects proper positioning of the upper sheet with respect to the lower sheet as the upper sheet is applied, as shown in FIG. 12B, Furthermore, the registration zone maintains proper registration between the upper and lower sheets as lower surface 55e comes into abutting contact with the upper surface 53e, as shown in FIG. 12C, allowing precise alignment when joinder is complete, as shown in FIG. 12D. Thus, in operation and use, joinder structure 51e is used in substantially the same manner as the joinder structures discussed above.

In still another embodiment shown in FIG. 12A, plane-to-plane joint 42f includes a flared aperture 91, which may be also be formed by punching, stamping, rolling, and/or other suitable means. The flared aperture also includes a fillet 87f which provides proper clearance for the deformation that occurs between lower planar segment 35f and registration zone 60f, as shown in FIG. 12c. In this embodiment, with our without a tapered zone, may be utilized. In operation and use, joinder structure 51f is used in substantially the same manner as the joinder structures discussed above.

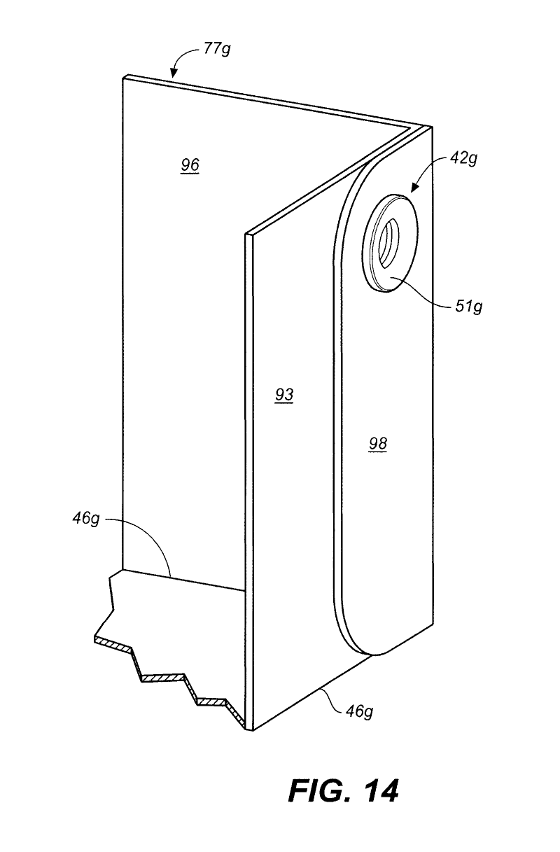

Turning now to FIG. 14, a further embodiment illustrates the manner in which the plane-to-plane joints of the present invention may be utilized to fasten a three-plane corner. Plane-to-plane joint 4g is substantially similar to joint 42a discussed above, except that single sheet 77g is folded about perpendicular fold lines 46g to form side walls. A first side wall 93 serves as a lower planar segment 35g having a joinder structure 51g, while a second side wall 96 includes a tab portion 98 which serves as second planar segment 39g having a corresponding aperture. As can be seen in FIG. 14, plane-to-plane joint 42g provides a simple, fastener-less means to secure the three-plane corner. The manner of assembling and securing joint 42g is similar to that described above.

With continued reference to FIG. 14, one will appreciate that the tab portion may be located outside (as shown in FIG. 14) or inside of the first side wall 93.

While the plane-to-plane joints of the present invention are particularly suited for use with fold lines populated with Assignee's bend-controlling structures, one will also appreciate that the plane-to-plane joints of the present invention may be utilized with fold lines formed by other suitable means, such as with press brakes and other conventional folding devices. Accordingly, one will appreciate that fold lines 46g may, but need not, include Assignee's bend-controlling displacements.

For convenience in explanation and accurate definition in the appended claims, the terms “up” or “upper”, “down” or “lower”, “inside” and “outside” are used to describe features of the present invention with reference to the positions of such features as displayed in the figures.

In many respects the modifications of the various figures resemble those of preceding modifications and the same reference numerals followed by subscripts “a”, “b”, “c”, “d”, “e”, “f”, and “g” designate corresponding parts.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the Claims appended hereto and their equivalents.

What is claimed is:

1. A plane-to-plane joint for securing planar segments of one or more sheet materials together, the plane-to-plane joint comprising:
a first planar segment having an upper planar surface;
a second planar segment having a lower planar surface;
a joinder structure monolithically formed on the first planar segment, the joinder structure including a transition zone located below the upper planar surface and a registration zone extending upwardly from the transition zone and out-of-plane from the planar segment;
an aperture in the second planar segment for receiving the joinder structure, the aperture being dimensioned and configured to cooperate with the registration zone of the joinder structure to register the relative position of the first and second planar segments when the lower planar surface abuts against the upper surface.

2. The plane-to-plane joint of claim 1 wherein,
the transition zone does not contact the second planar segment when the lower planar surface is placed against the upper planar surface.

3. The plane-to-plane joint of claim 1 wherein,
the joinder structure includes a tapered zone extending above the registration zone, the tapered zone being dimensioned and configured to engage the aperture and align the aperture relative to the registration zone.

4. The plane-to-plane joint of claim 3 wherein,
the registration zone is tubular and the tapered zone is frustoconical.

5. The plane-to-plane joint of claim 4 wherein,
the tapered zone has an open top.

6. The plane-to-plane joint of claim 4 wherein,
the joinder structure includes a closed semi-spherical top extending above the tapered zone.

7. The plane-to-plane joint of claim 4 wherein,
the joinder structure includes a closed semi-spherical top above the registration zone.

8. The plane-to-plane joint of claim 1 wherein,
the first planar segment and the second planar segment are monolithically formed.

9. The plane-to-plane joint of claim 1 wherein,
at least one of the joinder structure and the aperture are formed by stamping, punching, roil forming, or embossing.

10. The plane-to-plane joint of claim 1 wherein,
the joinder structure includes a tapered zone above the registration zone, the tapered zone being flattened against an upper surface of the second planar segment thereby permanently securing the first and second planar segments together.

11. The plane-to-plane joint of claim 10 wherein,
the tapered zone is flattened against the upper surface by stamping, punching, roll forming, or embossing.

12. A method for securing planar segments of one or more sheet materials together, the method comprising steps of:
monolithically forming a joinder structure on the first planar segment having an upper planar surface, the joinder structure including a transition zone located below the upper planar surface and a registration zone extending upwardly from the transition zone and out-of-plane from the planar segment; and
forming an aperture in a second planar segment having a lower planar surface, the aperture being dimensioned and configured to receive the joinder structure and to cooperate with the registration zone of the joinder structure to register the relative position of the first and second planar segments when the lower planar surface abuts against the upper surface.

13. The method of claim 12, further comprising the step of
monolithically forming the first and second planar segments from a single sheet of material.

14. The method of claim 12 wherein,
at least one of the monolithically forming step and the aperture forming step are accomplished by one of a stamping process, a punching process, a roll forming process, or an embossing process.

15. The method of claim 12 wherein,
the monolithically forming step is accomplished by forming a tapered zone extending above the registration zone, the tapered zone being dimensioned and configured to engage the aperture and align the aperture relative to the registration zone.

16. The method of claim 3, further comprising the step of
flattening the tapered zone against an upper surface of the second planar segment to permanently secure the first and second planar segments together.

17. The method of claim 10 wherein,
the tapered zone is flattened against the upper surface by stamping, punching, roll forming, or embossing.

18. A joint for securing planar segments of one or more sheet materials together, the joint comprising:
a first planar segment;
a second planar segment having an aperture therein; and
a joinder structure formed on the first planar segment, the joinder structure extending through the aperture in said second planar segment; whereby said joinder structure is dimensioned and configured to cooperate with the aperture to firmly secure the first and second planar segments when the joinder structure is deformed in such manner that the lower planar segment abuts against the upper planar segment.

19. The joint of claim 18 wherein the upper segment has a lower surface and the lower segment has an upper surface, said lower and upper surfaces abut one another when said joinder structure is appropriately deformed.

20. The joint of claim 18 wherein said upper and lower segments are formed from a single sheet of material.

21. A method for securing first and second planar segments of one or more sheet materials together, the method comprising steps of:
forming a joinder structure on the first planar segment,
forming an aperture in a second planar segment, the aperture being dimensioned and configured to receive the joinder structure to firmly secure the first and second planar segments when the joinder structure is deformed in such manner that the lower planar segment abuts against the upper planar segment.

22. The method of claim 21 wherein the upper segment has a lower surface and the lower segment has an upper surface, said lower and upper surfaces abut one another when said joinder structure is appropriately deformed.

23. The method of claim 21 wherein said upper and lower segments are formed from a single sheet of material.
